(19) United States
(12) Patent Application Publication
(10) Pub. No.: US 2009/0099323 A1
(43) Pub. Date: Apr. 16, 2009

(54) Melamine-formaldehyde resin solution and process for producing the same

(75) Inventors: Frank Schroder, Naunhof (DE); Christian Furst, Linz (AT); Daniel Jocham, Linz (AT); Oliver Katzenberger, Pasching (AT); Katarina Rot, Linz (AT); Johannes Fellner, Steyr (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI-AGROLINZ MELAMINE INTERNATIONAL GMBH, Linz (AT)

(21) Appl. No.: 11/920,035

(22) PCT Filed: May 10, 2006
(86) PCT No.: PCT/EP2006/004379

§ 371 Date: Sep. 3, 2008

(30) Foreign Application Priority Data
May 10, 2005 (DE) 10 2005 022 228.5

(51) Int. Cl. C08G 12/32; C08G 85/00

(52) U.S. Cl. 526/64; 528/254

(57) ABSTRACT

A melamine-formaldehyde resin solution having a formaldehyde/melamine ratio smaller than or equal to 1.5, at which it possesses a water compatibility ranging from 0.15 to 4.0 at 20° C., and a stability of at least 5 hours at a F/M ratio of 1.0, a stability of at least 6 hours at a F/M ratio of 1.1, a stability of at least 13 hours at a F/M ratio of 1.2, a stability of at least 24 hours at a F/M ratio of 1.3, a stability of at least 50 hours at a F/M ratio of 1.4, and a stability of at least 200 hours at a F/M ratio of 1.5, the stability of the resin solution being linearly dependent, within the range boundaries 1.0<F/M<1.1, 1.1<F/M<1.2, 1.2<F/M<1.3, 1.3<F/M<1.4, 1.4<F/M<1.5, upon the stabilities of the corresponding F/M range boundaries.

The invention relates to melamine-formaldehyde resin solutions as claimed in claim 1 or 2, to processes for their preparation as claimed in claim 22 or 23, to a resin powder as claimed in claim 35 and to the use of the resin solutions as claimed in claim 36.

In industry, water-dilutable melamine/formaldehyde resins have a variety of uses. They are used mainly as impregnating resins for the production of laminates with chemically and thermally exceptionally durable surfaces. In general, a paper layer impregnated with the melamine-formaldehyde resin solution is pressed together with a substrate material at elevated temperature, in the course of which the melamine-formaldehyde resin finally cures to form the durable top layer.

Typically, the impregnating resins are modified melamine-formaldehyde resins which have a formaldehyde/melamine ratio between 1.5 and 2.

Since the risk of undesired formaldehyde emissions exists at high formaldehyde contents, there are efforts to prepare melamine-formaldehyde resins with lower formaldehyde content. A low formaldehyde content is also desirable because the curing rate decreases with falling formaldehyde content and hence a greater processing window of the resins can be obtained. The difficulty in the preparation of such resins consists in the fact that, owing to the small amount of formaldehyde present based on the amount of melamine in the course of the synthesis, the dissolution operation of the melamine takes a relatively long time. One result is very highly condensed melamine-formaldehyde oligomer fractions; another is that unreacted melamine is also present in the finished resin solution. Very inhomogeneous resin solutions which have insufficient storage stability are thus obtained. Unlike standard resins with relatively high formaldehyde content, the latter is often only a few hours.

U.S. Pat. No. 3,520,715 describes a process for preparing melamine-formaldehyde resins which have a formaldehyde/melamine ratio of from 1.7 to 1.2. In this case, melamine is boiled in an aqueous formaldehyde solution which has been adjusted to from pH 8 to 9 at reflux until it dissolves in the alkaline medium. A disadvantage in this case is that, in the course of further reflux boiling, shortly after the dissolution, the condensation is so far advanced that the resin precipitates out when the solution is cooled.

U.S. Pat. No. 3,650,821 likewise describes the preparation of melamine-formaldehyde resins with a low formaldehyde content by reflux boiling of a mixture of formaldehyde, H₂O and melamine under basic conditions. The minimum achievable formaldehyde/melamine ratio is 1:1, a stability of the resin solution of about 12 h at room temperature being achieved by the resin solutions used with from F/M 1.3 to F/M 1.7. The resin solution therefore has to be processed further immediately. Only a paper which has been impregnated with the resin solution using a curing catalyst and dried is sufficiently storage- and transport-stable.

According to DE 3104420 A1, melamine-formaldehyde resin solutions having a formaldehyde/melamine ratio of less than 1.27 are prepared by mixing aqueous melamine solutions with formaldehyde and then, preferably with addition of modifiers, heating them to from 105 to 160° C. in a closed vessel. At this temperature and the corresponding elevated pressure, the condensation is conducted until a particular water compatibility is attained. A disadvantage in this process is that the resulting resin solutions—analogously to the ambient pressure process—have a low storage stability.

It is also known that melamine-formaldehyde resins with a low formaldehyde content can be prepared with addition of different modifiers, for instance carboxamides such as caprolactam or maleic monoamides or fumaric monoamides, sulfites, sulfonamides, carbamates, diols or polyols such as glycols, sugars or sugar alcohols, or else amino resin formers such as dicyandiamide, urea, guanidine, guanidine derivatives, aminotriazines, substituted aminotriazines such as (hydroxyl)alkylaminotriazines or guanamines, which are intended to improve the controllability of the reaction and the storage stability of the resulting resin solutions. This is achieved since the modifiers improve the dissolution operation of the melamine, dilute the resin solution, slow the intrinsic condensation of the melamine-formaldehyde precondensates and hence prevent the undesirably high degrees of condensation.

U.S. Pat. No. 5,681,917, for example, describes a process for preparing melamine-urea-formaldehyde resins with a low formaldehyde content by a multistage reaction of the formaldehyde with urea and melamine in alternation. The resulting melamine/urea/formaldehyde copolymer has an improved stability compared to pure melamine-formaldehyde resins with a low formaldehyde content.

DE 3 512 446 A1 describes the preparation of melamine-formaldehyde resins with a formaldehyde/melamine ratio of from 1.05 to 1.27, wherein hydroxyethylaminotriazine is used as a modifier. In this case, a defined amount of the modifier is metered into a melamine-formaldehyde precondensate, which is condensed until a particular water compatibility is attained.

A disadvantage in the case of addition of modifiers is that the modifiers are usually not fully chemically bonded into the network of the resin. Thus, they do not remain permanently in the resin, but rather can diffuse to the surface of the end product and form an undesired surface film there.

Furthermore, modifiers are expensive and complicate the resin synthesis, since they have to be metered in an exact amount and at the correct time.

The object of the invention consists in preparing, in a simple manner and without the addition of modifiers, a melamine-formaldehyde resin solution with a low formaldehyde/melamine ratio which does not have the disadvantages mentioned.

This is object is achieved by
a) preparing a mixture of melamine, formaldehyde and water which is under elevated pressure and has a pH greater than 7 by separately heating melamine and formaldehyde and then mixing them with one another, a mixing temperature Tₘ of greater than 100° C. being present in the course of mixing, then
b) conducting the reaction at the mixing temperature Tₘ until the clearing point is attained, then
c) continuing to condense at the condensation temperature Tₖ until the desired water compatibility is attained, then
   cooling the resin solution to room temperature and discharging it.

The reactants are heated separately, such that an elevated temperature is already present when the reactants are mixed.

The mixing temperature Tₘ is understood to mean that temperature which is established when melamine, formaldehyde and water are mixed.

The condensation temperature Tₖ is understood to mean that temperature at which, on attainment of the clearing point, the resin condensation is continued until the desired water compatibility is attained.

The object is also achieved by a melamine-formaldehyde resin solution (stable MF resin solution) which has an F/M ratio of ≦1.5 and a water compatibility of from 0.15 to 4.0 at 20° C. and a stability of at least 5 h at F/M 1.0, a stability of at least 6 h at F/M 1.1, a stability of at least 13 h at F/M 1.2, a stability of at least 24 h at F/M 1.3, a stability of at least 50 h at F/M 1.4, a stability of at least 200 h at F/M 1.5, where the stability of the resin solution within the range limits 1.0<F/M<1.1, 1.1<F/M<1.2, 1.2<F/M<1.3, 1.3<F/M<1.4, 1.4<F/H<1.5 has a linear dependence between the stabilities of the particular F/M range limits.

It is advantageous when the ratio

V1=(cumulative contents of melamine and monomers)/(cumulative contents of dimers, trimers and oligomers)

is between 1.1 and 1.7.

The inventive resin solutions are notable for very good storage stability and simple preparability. The resin solutions have neither very highly condensed fractions nor excessive fractions of unreacted melamine. As a result of this chemical homogeneity, they exhibit a storage stability which is from at least 5 h up to more than 250 h.

Particular preference is given to those melamine-formaldehyde resin solutions in which V1 is between 1.2 and 1.5 and/or which have the ratio

V2=(content of monomers)/(cumulative contents of dimers, trimers and oligomers)

between 0.8 and 1.4, especially between 0.85 and 1.25.

Melamine-formaldehyde resin solutions having these properties have particularly high stabilities which are up to >250 h.

Particular preference is given to those melamine-formaldehyde resin solutions which have a formaldehyde/melamine ratio of from 1.0 to 1.5, especially preferably from 1.1 to 1.4. These resins have sufficiently low formaldehyde contents with simultaneously good stability and preparation properties.

It is generally the case that the stabilities of the resin solutions rise with increasing F/M ratio.

It is also advantageous when the mixture has a pH between 7 and 14, in particular between 7.5 and 12. For pH adjustment, it is possible to use customary inorganic and organic bases, for example KOH, NaOH, Ca(OH)₂, amines and alkanolamines.

In the preparation of the liquid mixture, it is advantageous that the three reactants melamine, formaldehyde and water are heated separately. It is also possible to heat melamine and water together but separately from formaldehyde, and/or formaldehyde and water together, but separately from melamine. It is also possible to heat the melamine together with a portion of the water and to heat the formaldehyde together with a portion of the water.

It is particularly preferred when the melamine, as an aqueous suspension or as an aqueous solution, and the aqueous formaldehyde are heated separately to Tₘ greater than 100° C., and then the formaldehyde solution and a base for pH adjustment are metered under pressure into the efficiently stirred melamine suspension or solution.

In this manner, the reaction is started with a defined beginning at the mixing temperature Tₘ and continued up to the clearing point at Tₘ.

In contrast, when a combined mixture of all reactants is heated, the heating rate is influenced by apparatus parameters, which leads to different reaction times, reaction conditions and inhomogeneous resin properties. Another contributing factor is also that the heating rate is slow.

In embodiments of the inventive resins, in contrast, the absence of the heating time of a combined mixture of the reactants allows the reaction to be conducted in a reproducible and defined manner to form more homogeneous resin solutions.

The formaldehyde is preferably used in the form of an aqueous solution with a formaldehyde content of greater than 36% by weight.

A higher concentration of the formaldehyde is positive, since more water is available for suspension formation in this case, and hence the stirrability of the suspension, the distribution of the melamine and its dissolution operation are improved.

Generally, it is possible to use any desired formaldehyde source, for example methanol-stabilized, melamine-stabilized or unstabilized formaldehyde, or also paraformaldehyde.

It is advantageous when the mixing temperature Tₘ is between 100 and 200° C., more preferably between 110 and 150° C. The higher the mixing temperature Tₘ, the better the melamine solubility and hence the availability of the melamine for the reaction with the formaldehyde. The higher Tₘ is, the more homogeneous the resulting resin solution.

The pressure existing in the course of the reaction corresponds to the boiling pressure of the liquid mixture at the existing temperature. At a temperature Tₘ between 100 and 200° C., the elevated pressure is up to 10 bar gauge.

It is preferred when the mixing temperature Tₘ and the condensation temperature Tₖ are the same. This offers the advantage that the reaction regime is very simple and qualitatively high-value and stable resin solutions are nevertheless obtainable.

However, it is also possible that, after the clearing point has been attained, the temperature is lowered and condensation is continued at the lower temperature up to the desired water compatibility. The term “water compatibility” is explained in detail below in connection with a working example.

In this case, the condensation temperature Tₖ is lower than the mixing temperature Tₘ. The cooling from Tₘ to Tₖ can be effected either rapidly or slowly. A lower condensation temperature is supported by the fact that the condensation proceeds more slowly and the desired water compatibility can be established very efficiently as a result.

The inventive melamine-formaldehyde resin solution preferably has a solids content of from 20 to 80% by weight, more preferably from 40 to 70% by weight. Melamine-formaldehyde resin solutions with these solids contents can be stored and processed further particularly efficiently.

It is preferred when the melamine-formaldehyde resin solution is a water compatibility of from 0.2 to 1.5, especially that the condensation is conducted up to a water compatibility of from 0.4 to 1.5.

It is particularly advantageous when the water compatibility is from 0.2 to 1, especially that the condensation is conducted up to a water compatibility of from 0.5 to 1.

In these ranges of water compatibility, the inventive resin solutions have a maximum stability.

The storage stability of the inventive resin solutions is at least 5 h. Particularly advantageous resin solutions are those whose storage stability is at least 24 h. These resin solutions and especially those with a storage stability of more than 40 h offer a very good time buffer between the resin synthesis and the further processing of the resin solution.

It is advantageous when the inventive melamine-formaldehyde resin solution is spray-dried. The same further processing means are thus available as for the standard melamine-formaldehyde resins with a higher formaldehyde content, and the possible storage time of the resin powder is generally several times higher than that of the resin solutions.

The invention further provides a process in which
a) a mixture of melamine, formaldehyde and water which is under elevated pressure and has a pH greater than 7 is prepared by separately heating melamine and formaldehyde and then mixing them with one another, a mixing temperature Tₘ of greater than 100° C. being present in the course of mixing, then
b) the reaction is conducted at the mixing temperature Tₘ until the clearing point is attained, then
c) condensation is continued at the condensation temperature Tₖ until the desired water compatibility is attained, then
   the resin solution is cooled to room temperature and discharged.

Advantageously, the process is performed batchwise, in which case the reaction apparatus used is a stirred tank.

During the cooling from the condensation temperature Tₖ to below 100° C., noticeable postcondensation occurs. The condensation time required at Tₖ taking account of the postcondensation up to the desired water compatibility can be determined easily from preliminary experiments. It is also possible to monitor the condensation progress during the reaction by sampling and determining the water compatibility and hence to control the reaction.

For more detailed characterization of the resin solutions, it is possible, for example, to use gel permeation chromatography (GPC) and liquid chromatography with mass and/or UV detector (HPLC-MS, HPLC-UV).

The invention further provides a process for preparing a melamine-formaldehyde resin solution, wherein a mixture of melamine, formaldehyde and water which has a pH greater than 7 is reacted at a reaction temperature Tᵣ>100° C., the reaction temperature Tᵣ being attained within less than 5 minutes after the mixture is present, the reaction is conducted until the clearing point is attained, then condensation is continued at the condensation temperature Tₖ until the desired water compatibility is attained, then the resin solution is cooled to room temperature and discharged.

The pH is preferably from 7 to 14, more preferably from 7.5 to 12.

The solids content of the resin solution is preferably from 20 to 80% by weight, more preferably from 40 to 70% by weight.

It is possible to heat melamine and/or formaldehyde and/or water separately from one another and then to mix them with one another. The separate heating can be effected up to the reaction temperature Tᵣ. In this case, the reaction temperature Tᵣ corresponds to the mixing temperature Tₘ. In this case, the process is preferably performed batchwise in a stirred tank.

The separate heating can also be effected up to below the reaction temperature Tᵣ. In this case, the mixing temperature Tₘ is below the reaction temperature Tᵣ, and the further heating to the reaction temperature Tᵣ is effected within less than 5 minutes.

In this case, or when the reactants are not heated separately from one another but rather first mixed and then brought to Tᵣ within less than 5 minutes, the process is preferably performed continuously in a tubular reactor.

The tubular reactor may be formed from one vessel or a plurality of vessels connected to one another.

The temperature profile for establishing the desired temperatures Tₘ, Tᵣ, Tₖ in the tubular reactor is preferably established through separate heating circuits arranged over the reactor length. The residence time in the tubular reactor is between ideal plug flow and laminar flow. The throughput in the tubular reactor is guided by the required residence time at a defined reactor geometry which is needed to be able to achieve the desired properties of the end product.

In principle, the process according to the invention is also suitable for preparing already known melamine-formaldehyde resin solutions which have a formaldehyde/melamine ratio of greater than 1.5.

The inventive melamine-formaldehyde resin solution can be used, for example, for the production of laminates, composites, compression molding materials or compounds.

Two preferred embodiments of the invention will be illustrated by way of example hereinafter with reference to the figures. The figures show:

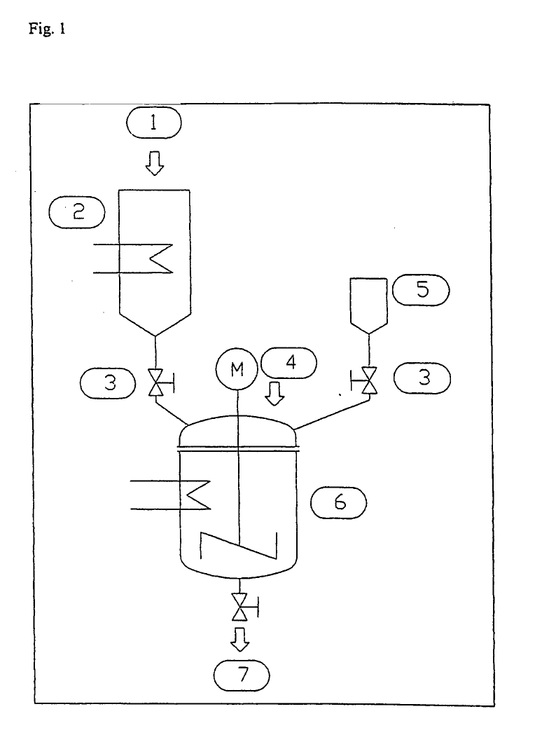

FIG. 1 one embodiment of a batchwise performance of the process in a stirred tank;

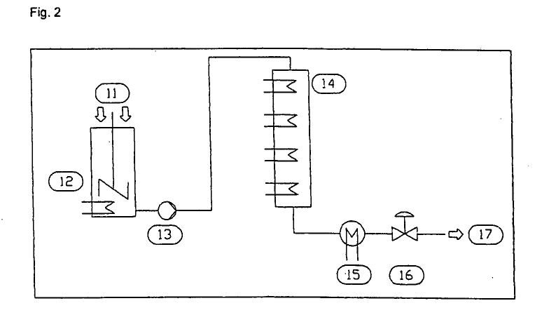

FIG. 2 one embodiment of a continuous performance of the process in a tubular reactor.

In FIG. 1, formaldehyde 1 is preheated to the desired temperature in the formaldehyde preheater 2. Melamine and water are introduced 4 into the batchwise stirred tank 6 and heated there up to the desired temperature. The amount of base required is initially charged in solution in the base metering vessel 5. As soon as the formaldehyde and the melamine-water mixture have reached the desired temperature, the valves 3 are opened, formaldehyde and the base are metered under pressure to the melamine-water mixture in the stirred tank 6 and the reaction mixture is prepared with the mixing temperature Tₘ. The reaction is conducted at Tₘ until the clearing point is attained. Subsequently, condensation is continued up to the desired water compatibility, in the course of which either the temperature Tₘ is retained or a lower condensation temperature Tₖ is established by reducing the heating in the stirred tank 6. After the desired resin properties have been attained, the resin solution is cooled and then the melamine-formaldehyde resin solution is discharged 7 at the bottom of the stirred tank 6.

A further embodiment is shown in FIG. 2. In this case, melamine, formaldehyde, water and base 11 are conveyed continuously in the desired mixing ratio into the heated and stirred suspension vessel 12. Melamine is metered in as a solid, while water, formaldehyde and base are conveyed into the vessel as a liquid mixture. The stirring results in a stabilization of the suspension. The pH of the suspension is monitored with a pH electrode and kept constant with a base metering pump. The suspension is drawn off continuously by a metering pump 13 at the bottom of the suspension vessel 12, which pumps the suspension into the tubular reactor 14 compressed to the required pressure, in which a temperature profile is established by means of a plurality of separate heating circuits. The melamine-formaldehyde resin solution which leaves at the bottom of the tubular reactor 14 is cooled to room temperature by means of the cooler 15 and discharged 17 via the decompression valve 16.

The drying of the resin solution can advantageously be achieved by a spray-drying. A classical spray-drying for this purpose uses an air stream into which the warm or else cold resin solution is introduced. The drying of the resin solution can also be achieved by means of flash-drying. In this case, the warm resin solution is dried with decompression (pressure lowering) without supplying air. To support the drying, it is also possible to introduce an air stream in the course of flash-drying.

The invention will be described hereinafter with reference to examples:

### EXAMPLES 1 TO 3

The experimental conditions of Examples 1 to 3 are shown in Table 1.

37% formalin solution is heated to the mixing temperature Tₘ in a heatable reservoir vessel. In parallel, melamine and water are likewise heated to the mixing temperature Tₘ in the reactor with vigorous stirring in suspension. The KOH is dissolved in 250 ml of water and initially charged in a small pressure vessel (base metering vessel) on the reactor. Once the formalin solution and the melamine suspension have reached the temperature Tₘ, the formalin solution and the dissolved KOH are metered in simultaneously under the pressure of the melamine suspension. The metering operation is complete after approx. 2 minutes. The suspension is now stirred under autogenous pressure at the temperature Tₘ up to the clearing point. Once the suspension has cleared to give the solution (clearing point), condensation is continued at the condensation temperature Tₖ up to the desired water compatibility of the resin solution and then the resin solution is cooled to room temperature. The resin solution has cooled to below 100° C. after about 5 minutes and to room temperature after about 20 minutes.

To characterize the resin solutions, the water compatibility at 20° C., the stability of the resin solution in the clear state at room temperature and the pH are determined. The composition is determined by means of HPLC/UV/MS, the proportions of melamine, sum of the monomers, sum of the dimers and sum of the trimers and oligomers being determined. The water compatibility is reported in [ml of water per ml of resin] and denotes the amount of water which can be added to the resin solution at 20° C. before persistent opacity of the resin occurs.

### EXAMPLES 4 AND 5, CONTINUOUS PROCESS

The experimental conditions of Examples 4 and 5 are shown in Table 2.

37% formalin solution, melamine, water and KOH are metered continuously into a suspension vessel which is temperature-controlled at the mixing temperature Tₘ, melamine being metered in with a gravimetric solids metering system, and formalin, water and KOH together as a solution with a liquid metering system. Stirring keeps the suspension stable. The pH of the suspension is kept between 9.6 and 9.8. A metering pump is used to bring the suspension to pressure p and pump it into the tubular reactor with a throughput D. The tubular reactor consists of the prereactor part with the volume Vol_{V} and postreactor part with the volume Vol_{N} connected in series. The prereactor is electrically heated; the postreactor is temperature-controlled by means of a temperature control circuit. In the prereactor, the suspension is heated to the reaction temperature Tᵣ within the heating time tₐ. The heated suspension is then transferred into the postreactor with the condensation temperature Tₖ. In the postreactor, the suspension then becomes clear and the resin solution is condensed further up to the desired degree of condensation within the condensation time t_{cond}. The resin solution is then cooled to room temperature in a cooler, the resin solution having been cooled to below 100° C. after 20 seconds and to room temperature after 1 minute.

The characterization is effected as described for Examples 1 to 3.

The parameters of the tubular reactor system (reaction temperatures, reaction volumes, residence times) for preparing a specific resin type are determined as a function of the planned throughput in preliminary experiments.

### COMPARATIVE EXAMPLE 1

Melamine, water, formalin solution and KOH are initially charged in the reactor with stirring at Tₘ (room temperature) and then heated to Tₖ 115° C. within approx. 25 minutes. Once the clearing point has occurred, the resin is condensed further under autogenous pressure at 115° C. until it has a water compatibility of 0.3 after the cooling. The characterization is effected as described in Examples 1 to 3.

### COMPARATIVE EXAMPLE 2

The experiment is performed as described for Comparative example 1, but with the change that the reaction takes place under reflux. After approx. 20 minutes, the state of reflux boiling has been attained and the reaction is continued up to the clearing point. After the clearing point has been attained, the reaction solution is cooled. At this time, the resin solution has already condensed to such an extent that further condensation brings about the precipitation of the resin out of the solution. The characterization is effected as described for Examples 1 to 3.

It is found that, owing to the inventive separate heating of the formalin and melamine reactants, much more stable resin solutions are obtained. Moreover, it is obvious that an increase in the mixing temperature Tₘ increases the stability of the resin solutions even further.

### REFERENCE NUMERAL LIST

1 Formaldehyde charging
2 Formaldehyde preheater
3 Valves
4 Melamine, water, base charging
5 Base metering vessel
6 Stirred tank
7 Melamine formaldehyde resin solution discharge
11 Melamine, formaldehyde, water, base charging
12 Suspension vessel
13 Metering pump
14 Tubular reactor
15 Cooler
16 Decompression valve
   17 Melamine-formaldehyde-resin solution discharge

TABLE 1
Examples 1-3

| | Example 1 | Example 2 | Example 3 |
|---|---|---|---|
| Molar F/M ratio | 1.3 | 1.2 | 1.3 |
| Melamine [kg] | 34.14 | 34.78 | 34.14 |
| 37% formalin [kg] | 28.62 | 26.91 | 28.62 |
| Water [kg] | 17.21 | 18.28 | 17.21 |
| KOH [kg] | 0.0344 | 0.0344 | 0.0344 |
| Mixing temperature Tₘ [° C.] | 120 | 130 | 140 |
| Condensation temperature Tₖ | 120 | 130 | 140 |
| [° C.] | | | |
| Solids content [% by wt.] | 56 | 56 | 56 |
| Clearing point [min] | 18 | 6.5 | 2.5 |
| Condensation time at Tₖ after | 7 | 6 | 3 |
| the clearing point [min] | | | |
| Water compatibility of the | 0.66 | 0.70 | 0.88 |
| resin solution at 20° C. [ml of | | | |
| water/ml of resin solution] | | | |
| Stability of the resin | 40 | 42 | 55 |
| solution - clear solution [h] | | | |
| pH of the resin solution | 9.5 | 9.5 | 9.5 |
| C1 | 1.33 | 1.3 | 1.44 |
| C2 | 1.06 | 0.98 | 1.14 |

TABLE 2
Examples 4 and 5

| | Example 4 | Example 5 |
|---|---|---|
| Molar F/M ratio | 1.3 | 1.2 |
| Melamine [kg/h] | 4.28 | 4.28 |
| 37% formalin [kg/h] | 3.62 | 3.31 |
| Water [kg/h] | 2.08 | 2.2 |
| KOH [kg/h] | 0.0022 | 0.0022 |
| Solids content [% by wt.] | 56 | 56 |
| Total throughput D [kg/h] | 10 | 10 |
| Pressure p [bar] | 6 | 6 |
| Mixing temperature Tₘ [° C.] | 25 | 25 |
| Prereactor volume Vol_{V} [ml] | 75 | 75 |
| Postreactor volume Vol_{N} [ml] | 975 | 975 |
| Reaction temperature Tᵣ [° C.] | 137 | 140 |
| Heating time tₐ to Tᵣ [min] | 0.6 | 0.6 |
| Condensation temperature Tₖ [° C.] | 138 | 140 |
| Condensation time t_{Cond} at Tᵣ and Tₖ | 7.9 | 6.5 |
| [min] | | |
| Water compatibility of the resin | 0.62 | 0.58 |
| solution at 20° C. [ml of water/ml | | |
| of resin solution] | | |
| Stability of the resin solution - | 30 | 23 |
| clear solution [h] | | |
| pH of the resin solution | 9.8 | 9.8 |
| C1 | 1.48 | 1.35 |
| C2 | 1.17 | 1.0 |

TABLE 3
Comparative examples 1 and 2

| | Comparative | Comparative |
|---|---|---|
| | example 1 | example 2 |
| Molar F/M ratio | 1.2 | 1.3 |
| Melamine [kg] | 31.05 | 30.48 |
| 37% formalin [kg] | 24.02 | 25.55 |
| Water [kg] | 24.89 | 23.93 |
| KOH [kg] | 0.0344 | pH of the |
| | | formalin |
| | | adjusted to |
| | | 8.35 |
| Mixing temperature Tₘ [° C.] | 25 | 25 |
| Condensation temperature Tₖ [° C.] | 115 | 100 |
| | | (reflux) |
| Clearing point [min] | 32.5 | 100 |
| Condensation time at Tₖ after the | 30 | 0 |
| clearing point [min] | | |
| Water compatibility of the resin | 0.3 | 0.19 |
| solution at 20° C. [ml of water/ml | | |
| of resin solution] | | |
| Stability of the resin solution - | 7 | 3 |
| clear solution [h] | | |
| pH of the resin solution | 9.5 | 9.5 |
| C1 | 1.5 | 1.03 |
| C2 | 1.15 | 0.79 |

The resin solutions prepared in accordance with the invention can be prepared in a simple and reproducible manner and have significantly better stabilities than the comparative examples from the literature.

1-37. (canceled)

38: A melamine-formaldehyde resin solution having a formaldehyde/melamine ratio of less than or equal to 1.5, preparable by a process in which
a) a mixture of melamine, formaldehyde and water which is under elevated pressure and has a pH greater than 7 is prepared by separately heating melamine and formaldehyde and then mixing them with one another, a mixing temperature Tₘ of greater than 100° C. being present in the course of mixing, then
b) the reaction is conducted at the mixing temperature Tₘ until the clearing point is attained, then
c) condensation is continued at a condensation temperature Tₖ until the desired water compatibility is attained, then the resin solution is cooled to room temperature and discharged,
wherein the solution has a water compatibility of from 0.15 to 4.0 at 20° C. and a stability of at least 5 h at F/M 1.0, a stability of at least 6 h at F/M 1.1, a stability of at least 13 h at F/M 1.2, a stability of at least 24 h at F/M 1.3, a stability of at least 50 h at F/M 1.4, a stability of at least 200 h at F/M 1.5, where the stability of the resin solution within the range limits 1.0<F/M<1.1, 1.1<F/M<1.2, 1.2<F/M<1.3, 1.3<F/M<1.4, 1.4<F/M<1.5 has a linear dependence between the stabilities of the particular F/M range limits.

39: The melamine-formaldehyde resin solution as claimed in claim 38, wherein the ratio
V1=(cumulative contents of melamine and monomers)/(cumulative contents of dimers, trimers and oligomers)
is between 1.1 and 1.7.

40: The melamine-formaldehyde resin solution as claimed in claim 38, wherein the ratio
V2=(content of monomers)/(cumulative contents of dimers, trimers and oligomers)
is between 0.8 and 1.4.

41: The melamine-formaldehyde resin solution as claimed in claim 39, wherein V1 is between 1.2 and 1.5.

42: The melamine-formaldehyde resin solution as claimed in claim 40, wherein V2 is between 0.85 and 1.25.

43: The melamine-formaldehyde resin solution as claimed in claim 38, wherein the formaldehyde/melamine ratio is from 1.0 to 1.5.

44: The melamine-formaldehyde resin solution as claimed in claim 38, wherein the formaldehyde/melamine ratio is from 1.1 to 1.4.

45: The melamine-formaldehyde resin solution as claimed in claim 38, wherein the pH is from 7 to 14.

46: The melamine-formaldehyde resin solution as claimed in claim 38, wherein the pH is from 7.5 to 12.

47: The melamine-formaldehyde resin solution as claimed in claim 38, wherein the melamine, as an aqueous suspension or as an aqueous solution, and the aqueous formaldehyde are heated separately to Tₘ greater than 100° C., and then the formaldehyde solution and a base for pH adjustment are metered under pressure into the efficiently stirred melamine suspension or solution.

48: The melamine-formaldehyde resin solution as claimed in claim 38, wherein the formaldehyde is used as an aqueous solution with a formaldehyde content greater than 36% by weight.

49: The melamine-formaldehyde resin solution as claimed in claim 38, wherein the mixing temperature Tₘ is between 100 and 200° C.

50: The melamine-formaldehyde resin solution as claimed in claim 38, wherein the mixing temperature Tₘ is between 110 and 150° C.

51: The melamine-formaldehyde resin solution as claimed in claim 38, wherein the mixing temperature Tₘ and the condensation temperature Tₖ are the same.

52: The melamine-formaldehyde resin solution as claimed in claim 38, wherein the condensation temperature Tₖ is lower than the mixing temperature Tₘ.

53: The melamine-formaldehyde resin solution as claimed in claim 38, wherein the solids content is from 20 to 80% by weight.

54: The melamine-formaldehyde resin solution as claimed in claim 38, wherein the solids content is from 40 to 70% by weight.

55: The melamine-formaldehyde resin solution as claimed in claim 38, wherein the water compatibility is from 0.2 to 1.5.

56: The melamine-formaldehyde resin solution as claimed in claim 38, wherein the water compatibility is from 0.2 to 1.

57: The melamine-formaldehyde resin solution as claimed in claim 38, wherein the resin solution has a storage stability of at least 24 h.

58: A process for preparing a melamine-formaldehyde resin solution as claimed in claim 38, wherein
a) a mixture of melamine, formaldehyde and water which is under elevated pressure and has a pH greater than 7 is prepared by separately heating melamine and formaldehyde and then mixing them with one another, a mixing temperature Tₘ of greater than 100° C. being present in the course of mixing, then
b) the reaction is conducted at the mixing temperature Tₘ until the clearing point is attained, then
c) condensation is continued at a condensation temperature Tₖ until the desired water compatibility is attained, then the resin solution is cooled to room temperature and discharged.

59: A process for preparing a melamine-formaldehyde resin solution as claimed in claim 38, wherein a mixture of melamine, formaldehyde and water which has a pH greater than 7 is reacted at a reaction temperature Tᵣ>100° C., the reaction temperature Tᵣ being attained within less than 5 minutes after the mixture is present, the reaction is conducted until the clearing point is attained, then condensation is continued at the condensation temperature Tₖ until the desired water compatibility is attained, then the resin solution is cooled to room temperature and discharged.

60: The process as claimed in claim 59, wherein melamine and formaldehyde are heated separately and then mixed with one another.

61: The process as claimed in claim 58, wherein the process is performed batchwise in a stirred tank.

62: The process as claimed in claim 58, wherein the process is performed continuously in a tubular reactor.

63: The process as claimed in claim 62, wherein the temperature profile in the tubular reactor is established by separate heating circuits arranged over the reactor length.

64: The process as claimed in claim 58, wherein the pH is from 7 to 14.

65: The process as claimed in claim 58, wherein the pH is from 7.5 to 12.

66: The process as claimed in claim 58, wherein the solids content of the resin solution is from 20 to 80% by weight.

67: The process as claimed in claim 58, wherein the solids content of the resin solution is from 40 to 70% by weight.

68: The process as claimed in claim 58, wherein the melamine-formaldehyde solution is spray-dried.

69: The process as claimed in claim 68 wherein the spray-drying of the warm or cold resin solution is effected by means of a gas stream.

70: The process as claimed in claim 68 wherein the spray-drying is effected by means of flash-drying, in which the drying is effected with simultaneous decompression.

71: The process as claimed in claim 70, wherein a gas stream is additionally supplied.
